(19) United States
(12) Patent Application Publication
(10) Pub. No.: US 2014/0164193 A1
(43) Pub. Date: Jun. 12, 2014

(54) ELECTRONIC RECEIPT SYSTEM, COMMODITY SALES DATA PROCESSING APPARATUS, ELECTRONIC RECEIPT MANAGEMENT SERVER AND METHOD

(71) Applicant: Toshiba Tec Kabushiki Kaisha, Tokyo (JP)

(72) Inventors: Taro Ando, Shizuoka-ken (JP); Keiichi Hasegawa, Tokyo-to (JP); Satoru Ishihara, Osaka-fu (JP); Tsuyoshi Gotanda, Tokyo-to (JP); Akiko Susaki, Tokyo-to (JP); Makoto Fukasawa, Gunma-ken (JP); Yasuhiro Arai, Shizuoka-ken (JP)

(73) Assignee: Toshiba Tec Kabushiki Kaisha, Tokyo (JP)

(21) Appl. No.: 14/097,362

(22) Filed: Dec. 5, 2013

(30) Foreign Application Priority Data
Dec. 11, 2012 (JP) 2012-270837
Mar. 1, 2013 (JP) 2013-041245
Jun. 17, 2013 (JP) 2013-126604

(51) Int. Cl. G06Q 40/00

(52) U.S. Cl. CPC G06Q 40/12
USPC 705/30

(57) ABSTRACT

An electronic receipt system generates electronic receipt information associated with commodity sales data in association with a member code of a consumer, stores company codes in a storage section in association with electronic receipt information in a plurality of electronic receipt management units corresponding to company codes representing different companies, and manages electronic receipt information associated with the plurality of company codes stored in each electronic receipt management unit. Then, the electronic receipt system displays, to an information processing apparatus corresponding to a member code of a consumer, the electronic receipt information containing at least one company code corresponding to the member code on a display section in association with company code.

### CROSS-REFERENCE TO RELATED APPLICATION

The present application is based upon and claims the benefit of priorities from Japanese Patent Application No. 2013-126604 filed on Jun. 17, 2013 and Japanese Patent Application No. 2013-041245 filed on Mar. 1, 2013 and Japanese Patent Application No. 2012-270837 filed on Dec. 11, 2012, the entire contents of which are hereby incorporated by reference.

### FIELD

Embodiments described herein relate to a commodity sales data processing apparatus, an electronic receipt management server and method.

### BACKGROUND

Conventionally, an electronic receipt system is known in which a receipt handed from a store to a consumer, that is, a shopper at the time of commodity settlement is electronically sent to a portable terminal and the like of a consumer.

By transforming a receipt into electronic data like this, the consumption of receipt paper can be reduced, which is beneficial to a store which introduces such a system.

In addition, it is also known that commodity promotion and advertisement can be carried out by electronically attaching a coupon and the like relating to a purchased commodity to the electronic receipt.

### BRIEF DESCRIPTION OF THE DRAWINGS

FIG. 1 is a diagram illustrating a whole constitution of an electronic receipt system according to an embodiment;

FIG. 3 is a block diagram illustrating a constitution of main portions of a portable terminal;

FIG. 4 is a block diagram illustrating a constitution of main portions of a POS terminal;

FIG. 5 is a block diagram illustrating a constitution of main portions of an electronic receipt management server;

FIG. 7 is a schematic view exemplarily illustrating data configuration of electronic receipt information;

FIG. 8 is a function block diagram relating to an electronic receipt processing carried out in a POS terminal;

FIG. 9 is a flowchart illustrating a flow of an electronic receipt processing;

FIG. 10 is a function block diagram relating to an electronic receipt management processing and a commodity information sending processing carried out in an electronic receipt management server;

FIG. 11 is a flowchart illustrating a flow of an electronic receipt management processing and a commodity information sending processing;

FIG. 12 is a function block diagram relating to an electronic receipt reception processing and an electronic receipt browsing processing carried out in a portable terminal;

FIG. 13 is a flowchart illustrating a flow of an electronic receipt reception processing and an electronic receipt browsing processing;

FIG. 14 is a front view illustrating a display example in a portable terminal;

FIG. 16 is a front view illustrating a display example in a portable terminal;

FIG. 19 is a front view illustrating a display example in a portable terminal; and

FIG. 20 is a flowchart illustrating a flow of an electronic receipt reception processing and an electronic receipt browsing processing.

### DETAILED DESCRIPTION

In accordance with one embodiment, an electronic receipt system comprises a commodity sales data storage unit, a data generation unit, a modification information storage unit, an addition unit, and an output unit. The commodity sales data storage unit stores commodity sales data containing a member code for identifying a consumer and transaction data of a commodity associated with the member code in a storage section in association with the member code. The data generation unit associates a company code for identifying a seller of a commodity with the commodity sales data to generate electronic receipt information. The modification information storage unit stores modification information to be added to electronic receipt information in a storage section for each of a plurality of company codes. The addition unit reads modification information based on the company code contained in the electronic receipt information generated by the data generation unit from the storage section, and adds to the electronic receipt information. The output unit outputs the electronic receipt information.

One embodiment is described in detail based on accompanying drawings.

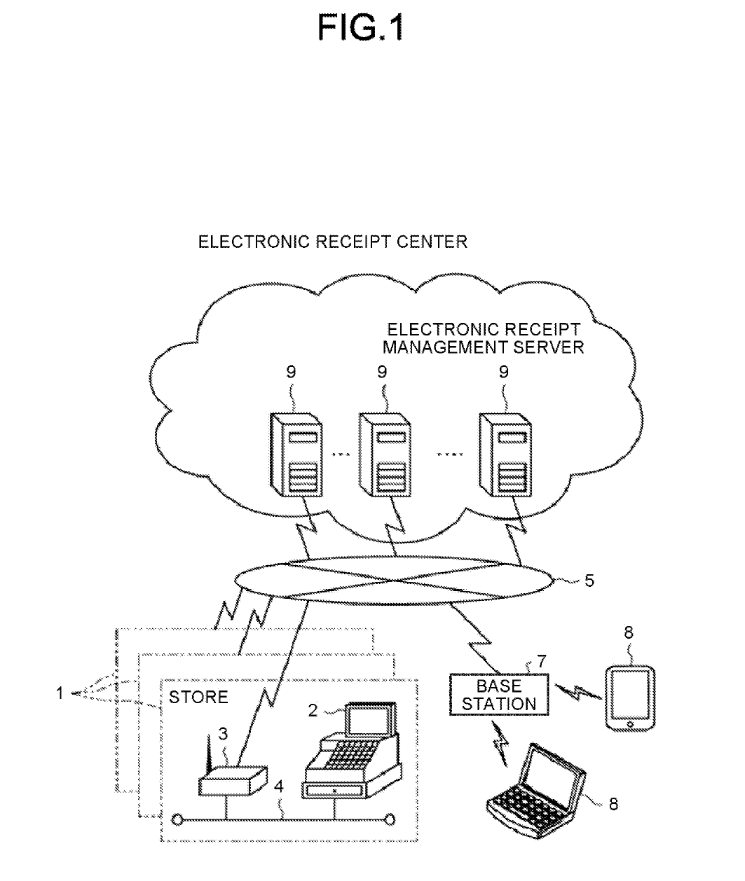

FIG. 1 is a diagram illustrating a whole constitution of an electronic receipt system according to an embodiment. As shown in FIG. 1, in a store 1 connected with a company serving as a commodity or service seller through a network 5, a POS (Point of Sales) terminal 2 (only one is shown in FIG. 1, however, the number is not limited) serving as a commodity sales_{.} data processing apparatus executing a commodity sales data processing, and a router 3 are arranged. The store 1 is a store or a chain store (hereinafter referred to as store) such as a convenience store, a supermarket, a foodstuff store, a drugstore, an apparel store, a home electric appliance store, a department store, a household goods store, and a restaurant. The POS terminal 2 and the router 3 are connected through a LAN (Local Area Network) 4 in the store. The router 3 connects the LAN 4 in the store with the network 5 serving as an internet or a VPN (Virtual Private Network). In addition, a store server, though not shown in figures, unifying the POS terminal 2 may also be arranged in the store 1.

A portable terminal 8 is connected with the network 5 through a base station 7 carrying out wireless communication according to a standard such as Wi-Fi (Wireless Fidelity). The portable terminal 8 is an information processing apparatus, for example, a smartphone, a mobile phone, a PDA (Personal Digital Assistant), a tablet computer and the like, provided with a Web browser. In addition, an information processing apparatus such as a notebook PC, or a personal computer may also be used instead of the portable terminal 8.

Further, an electronic receipt management server 9, which is arranged in an electronic receipt center to function as a receipt management server for customer for collectively storing and managing electronic receipt information of various companies operating stores, is also connected with the network 5. A consumer who carried out a membership registration in advance to receive electronic receipt service can obtain electronic receipt information from the electronic receipt management server 9 through the network 5 using the portable terminal 8. The electronic receipt management server 9 is managed by, for example, a third party organization different from the company operating the store. Further, a service (application) may also be provided in which the function of collectively managing electronic receipt information of each company representing the company operating the store with a plurality of company codes is in, for example, a state of a Saas (Software as a Service) serving as one kind of cloud computing.

In addition, for example, the membership registration for a consumer to receive electronic receipt service is carried out as following. The consumer sends a blank mail to a member management server from the portable terminal 8 through the network 5. The member management server sends a URL (Uniform Resource Locator) indicating a page for membership registration to the address of the received mail. The consumer accesses the URL indicating the page for membership registration from the portable terminal 8, enables an input screen to be displayed, and then inputs items necessary for the membership registration. After the consumer inputs the necessary items, the portable terminal 8 displays an input confirmation screen. After the input confirmation by the consumer, the membership registration to a member master is executed. Then the member management server sends a membership registration completion mail containing a member code and a password to the portable terminal 8. Thereby, the membership registration is ended.

In the electronic receipt system with such a constitution, the electronic receipt information representing the settlement content generated when the commodity sales data processing is carried out in the POS terminal 2 of the store 1 is sent to the electronic receipt management server 9 through the network 5, and then the electronic receipt information is sent from the electronic receipt management server 9 to the portable terminal 8 of the member. The member displays the electronic receipt information on a display section of the portable terminal 8 to confirm the content. Further, the electronic receipt management server 9 discloses the electronic receipt information on Web. The portable terminal 8 provided with a Web browser can download the electronic receipt information disclosed on Web to the portable terminal 8 by designating the URL (Uniform Resource Locator), and browse the electronic receipt information using the Web browser. In addition, application software may also be installed in the portable terminal 8 to browse the electronic receipt information.

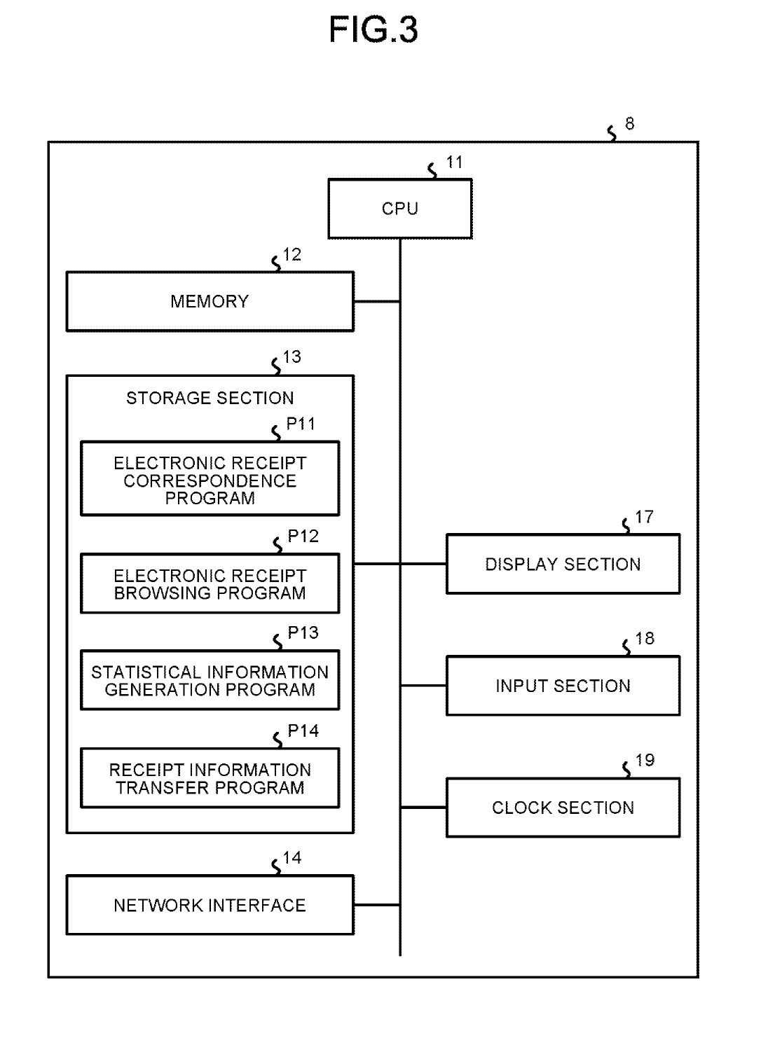

The portable terminal 8 stores the member code and password acquired by the consumer in the aforementioned manner in a storage section 13 (with reference to FIG. 3) and the like. There are many methods for outputting the stored member code, such as a display based on barcode, a display based on two-dimensional code, and a transmission based on information communication based on NFC (Near Field Communication) serving as proximity wireless communication.

The association between the member code acquired by the consumer to receive electronic receipt service and the existing company member card of a point service and the like operated by a company such as a chain store may also be realized by using the POS terminal 2 of each retail store or the portable terminal 8 of each customer.

Herein, operation examples of the association between the member code acquired by the consumer and the existing company member card are described in detail.

1. operation example in the POS terminal 2 of a store

(1) First, a checker operating the POS terminal 2 confirms whether or not to offer an electronic receipt service at the time of commodity registration (settlement), and confirms whether or not there is a point card. When an electronic receipt service is offered, the consumer presents the portable terminal 8 and the point card.

(2) The checker respectively inputs the member code stored in the portable terminal 8 and the company member code of the point card to the POS terminal 2. Herein, the input of the member code stored in the portable terminal 8 to the POS terminal 2 depends on an I/O arranged in the POS terminal 2, however, the aforementioned barcode, two-dimensional code and the NFC may also be used.

(3) The POS terminal 2 sends the member code and the company member code of the point card read in transaction (2) to the electronic receipt management server 9.

(4) The electronic receipt management server 9 receives the information sent in (3), and registers the company member code in the electronic receipt management server 9 in association with the member code if the electronic receipt information representing the settlement content generated when the commodity sales data processing is carried out in the POS terminal 2 of the store 1 and the member code, and the company member code of the point card are simultaneously sent for the first time.

Thereafter, the consumer can receive a service in the electronic receipt system and a point granting service by presenting the portable terminal 8 or the point card only.

2. operation example in the portable terminal 8

(1) First, the consumer accesses a specific URL from his/her own portable terminal 8, or logs in the point card registration menu through the application installed in the portable terminal 8. The consumer inputs or selects a company issuing the point card to be registered. Then the consumer inputs the company member code of the point card to be registered, presses the registration button after confirming the number to send the registration content to the electronic receipt management server 9. In addition, the input of the company member code can be carried out manually or through camera photographing, or magnetic reading and the like.

(2) The electronic receipt management server 9 receives the registration content sent from the portable terminal 8 in (1), compares with the customer information of each company, and sends a confirmation display screen to the portable terminal 8 of the consumer.

(3) The consumer confirms the confirmation display screen sent from the electronic receipt management server 9, and presses an agreement button; then the association between the member code of the electronic receipt and the existing company member card is established.

In this way, by managing the service in the electronic receipt system and the point granting service with a unique member code of the electronic receipt, it is possible to receive the service in the electronic receipt system by presenting a point card in a conventional store owning the point card, or presenting the portable terminal 8 in a store having no point card. As a result, the member code of the electronic receipt can function as an HUB associating each company member card of each company.

Hereinafter, including this point, the constitution of each section of the electronic receipt system according to the present embodiment is described in detail.

First, the constitution of main portions of the portable terminal 8 serving as an information processing apparatus is described with reference to the block diagram in FIG. 3. As shown in FIG. 3, the portable terminal 8 consists of a CPU (Central Processing Unit) 11 constituting a main body of a control section, a memory 12 for storing data temporarily, a storage section 13, which is readable according to a command from the CPU 11, for storing a program or data and the like, a network interface 14 connected with various public networks including the network 5, a display section 17 capable of displaying various kinds of information, an input section 18 for operating the portable terminal 8, a clock section 19 for measuring time, and the like. The input section 18 is a touch panel laminated on the display section 17, or keys arranged on a hosing.

In the storage section 13, in addition to the Web browser for browsing various kinds of information (content) disclosed on Web, an electronic receipt correspondence program P11 for receiving the electronic receipt information generated in the commodity sales data processing after the settlement from the electronic receipt management server 9, and an electronic receipt browsing program P12 for browsing the received electronic receipt information are also installed in advance.

In addition, a statistical information generation program P13 is also pre-installed in the storage section 13 to generate statistical information obtained through the statistics of the electronic receipt information received from each company (which will be described later) based on a company code or a code of business type and business style.

In addition, the electronic receipt correspondence program P11, the electronic receipt browsing program P12, the statistical information generation program P13, and a receipt information transfer program P14 executed by the portable terminal 8 are recorded and provided in a computer-readable recording medium such as a CD-ROM, a flexible disk (FD), CD-R, DVD (Digital Versatile Disk) and the like in the form of installable or executable file.

Further, the electronic receipt correspondence program P11, the electronic receipt browsing program P12, the statistical information generation program P13, and the receipt information transfer program P14 executed by the portable terminal 8 may also be stored in a computer connected with a network such as an internet, and then downloaded via the network. Further, the electronic receipt correspondence program P11, the electronic receipt browsing program P12, the statistical information generation program P13, and the receipt information transfer program P14 executed by the portable terminal 8 may also be provided or distributed via a network such as an internet.

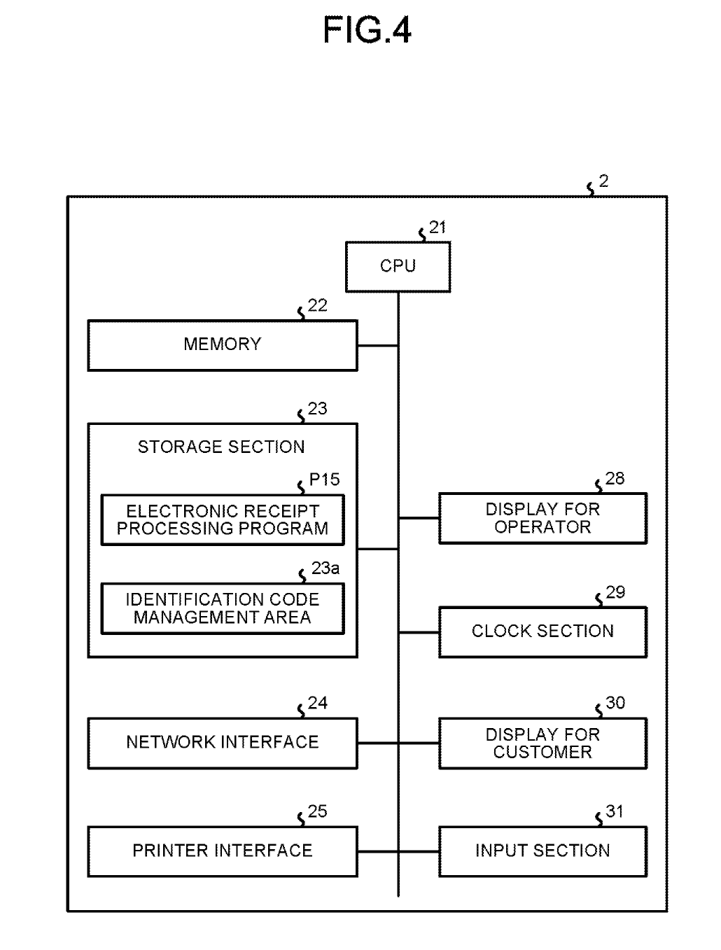

Next, the constitution of main portions of the POS terminal 2 serving as a commodity sales data processing apparatus is described with reference to the block diagram in FIG. 4. As shown in FIG. 4, the POS terminal 2 consists of a CPU (Central Processing Unit) 21 constituting a main body of a control section, a memory 22 for storing data temporarily, a storage section 23, which is readable according to a command from the CPU 21, for storing a program or data and the like, a network interface 24 connected with the LAN 4 in the store, a printer interface 25 connected with a printer, a display for operator 28 for displaying various kinds of information to the operator, a clock section 29 for measuring time, a display for customer 30 for displaying various kinds of information to the customer, and an input section 31 for operating the POS terminal 2.

In the storage section 23, in addition to the register code of the POS terminal 2, an identification code management area 23a serving as an area for pre-storing a company code (an identification code of a company operating the store), a code of business type and business style, and a store code indicating the store 1 in which the POS terminal 2 is arranged, and the like, is also guaranteed. Herein, the code of business type and business style is a code (category code) for distinguishing the business type and business style of a store as, for example, a convenience store, a supermarket, a department store, a pharmacy, a restaurant, an eating house and the like. In addition, such a business type and business style can be randomly changed according to the preference of the user.

Further, in addition to software for executing various POS jobs including the commodity sales data processing, an electronic receipt processing program P15 is also pre-installed in the storage section 23 to process the electronically processed electronic receipt information instead of the receipt printed and issued at the time of commodity sales data processing.

In addition, the electronic receipt processing program P15 executed by the POS terminal 2 is recorded and provided in a computer-readable recording medium such as a CD-ROM, a flexible disk (FD), CD-R, DVD (Digital Versatile Disk) and the like in the form of installable or executable file.

Further, the electronic receipt processing program P15 executed by the POS terminal 2 may also be stored in a computer connected with a network such as an internet, and then downloaded via the network. Further, the electronic receipt processing program P15 executed by the POS terminal 2 may also be provided or distributed via a network such as an internet.

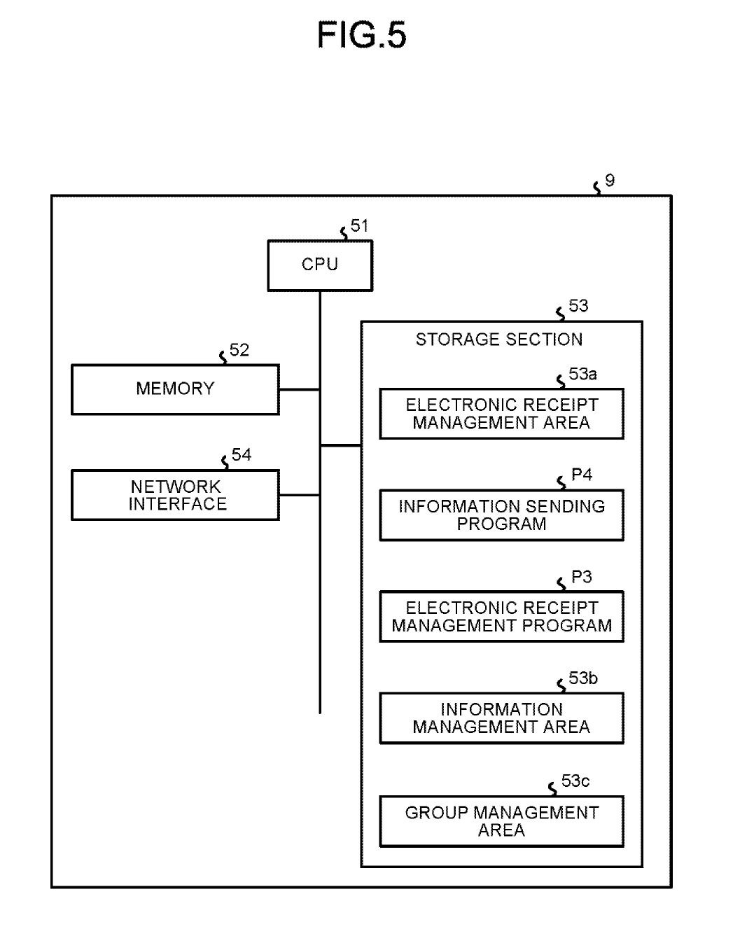

Next, the constitution of main portions of the electronic receipt management server 9 functioning as a receipt management server for customer is described with reference to the block diagram in FIG. 5. The electronic receipt management server 9 consists of a CPU (Central Processing Unit) 51 constituting a main body of a control section, a memory 52 for storing data temporarily, a storage section 53, which is readable according to a command from the CPU 51, for storing a program or data and the like, a network interface 54 connected with the network 5.

In the storage section 53, an electronic receipt management area 53a serving as an area for collectively storing the electronic receipt information of various companies operating stores is guaranteed. More specifically, the electronic receipt management area 53a manages the electronic receipt information of various companies operating stores for each member.

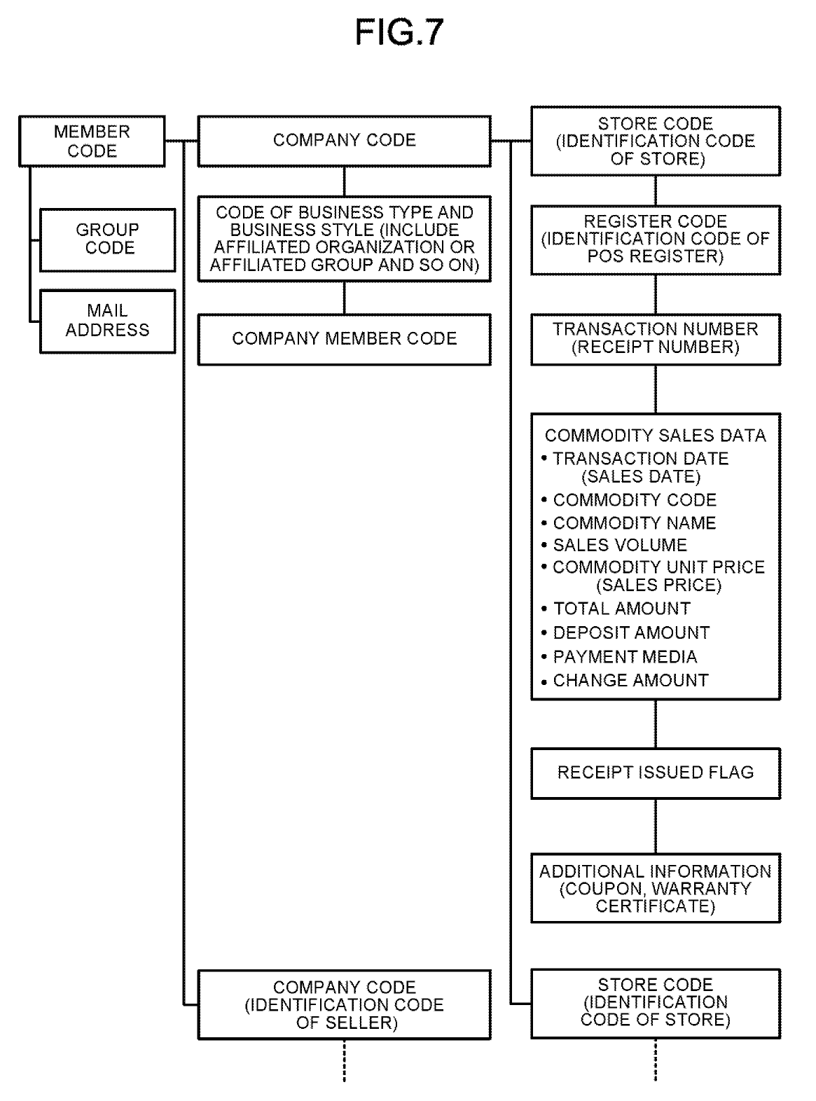

Herein, the data configuration of the electronic receipt information stored in the electronic receipt management area 53a is described. FIG. 7 is a schematic view exemplarily illustrating the data configuration of the electronic receipt information. As shown in FIG. 7, the electronic receipt information contains, in association with the member code uniquely determined for each consumer, a company code (an identification code of a company operating a store), a code of business type and business style (including an affiliated organization or affiliated group besides the business type and business style such as a CVS and a supermarket and the like), a company member code of a company member card.

Further, as shown in FIG. 7, the electronic receipt information contains, in association with the member code, a store code (an identification code of a store), a register code (an identification code of the POS terminal 2), a transaction number (receipt number), commodity sales data, a receipt issued flag, additional information (coupon, warranty certificate and the like), and the like.

As shown in FIG. 7, the commodity sales data contains, for each commodity, transaction date (sales date), commodity code, commodity name, sales volume and commodity unit price (sales price), as well as total amount, deposit amount, payment media, change amount and the like.

In addition, the electronic receipt information shown in FIG. 7 contains the additional information (coupon, warranty certificate and the like), however, it is not limited to this, the electronic receipt information and the additional information (coupon, warranty certificate and the like) may also be managed respectively.

In addition, as shown in FIG. 7, the electronic receipt information contains a mail address and a group code in association with the member code. The mail address is used for sending an electronic receipt update notification which will be described later and the electronic receipt information.

Further, in the storage section 53, an electronic receipt management program P3 is pre-installed to manage the electronic receipt information received from each company with the electronic receipt management area 53a.

Further, an information management area 53b is arranged in the storage section 53 to store various modification data (additional information) associated with desired commodity, member, company and store. Herein, the modification data (additional information) refers to access information such as a URI, linked to a homepage associated with the campaign of a company, a URL linked to a homepage associated with the CM of a company, a URL linked to a coupon of a company, and the like, and the information such as the modification data (additional information) of the electronic receipt such as a store name logo or the warranty certificate data and the like corresponding to each code of the company code or the store code. Compared with the electronic receipt information, the modification data (additional information) such as the store name logo is data with large file capacity, and is created in a data form such as BMP and the like.

That is, the information management area 53b of the storage section 53 is a modification information storage unit for storing the modification information to be added to the electronic receipt information in a storage section for each of a plurality of company codes.

Further, an information sending program P4 is pre-installed in the storage section 53 for sending the electronic receipt information to the portable terminal 8.

In addition, the electronic receipt management program P3 and the information sending program P4 executed by the electronic receipt management server 9 are recorded and provided in a computer-readable recording medium such as a CD-ROM, a flexible disk (FD), CD-R, DVD (Digital Versatile Disk) and the like in the form of installable or executable file.

Further, the electronic receipt management program P3 and the information sending program P4 executed by the electronic receipt management server 9 may also be stored in a computer connected with a network such as an internet, and then downloaded via the network. Further, the electronic receipt management program P3 and the information sending program P4 executed by the electronic receipt management server 9 may also be provided or distributed via a network such as an internet.

Next, the operations of each section of the system according to the present embodiment are described.

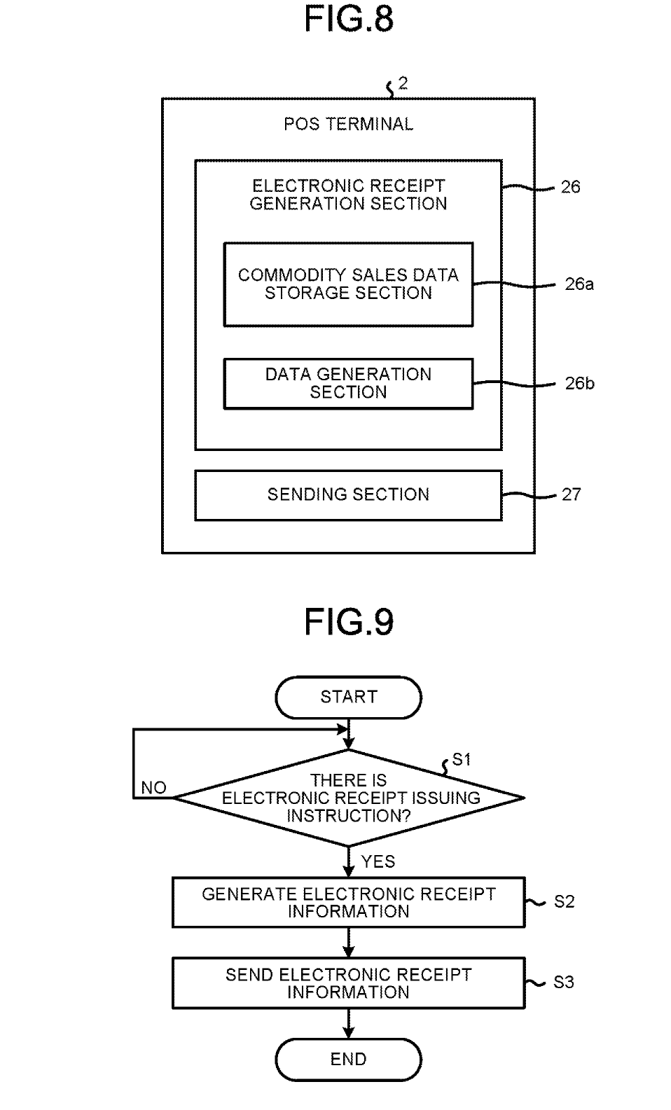

First, the electronic receipt processing executed by the CPU 21 of the POS terminal 2 by operating according to the electronic receipt processing program P15 is described with reference to the function block diagram in FIG. 8 and the flowchart in FIG. 9.

As shown in FIG. 8, the electronic receipt processing program P15 executed by the POS terminal 2 has a module constitution including an electronic receipt generation section 26 functioning as an electronic receipt generation unit and a sending section 27 functioning as a sending unit. As practical hardware, by reading the electronic receipt processing program P15 from the storage section 23 and then executing it using the CPU 21, the aforementioned sections are loaded in the memory 22, and the electronic receipt generation section 26 and the sending section 27 are generated in the memory 22.

The electronic receipt generation section 26 generates, in association with the member code of the consumer, electronically processed electronic receipt information including the company code indicating the company operating the store instead of a receipt printed and issued at the time of the commodity sales data processing.

More specifically, the electronic receipt generation section 26 comprises a commodity sales data storage section 26a serving as a commodity sales data storage unit for storing commodity sales data containing a member code for identifying a consumer and the transaction data of a commodity associated with the member code in a storage section in association with the member code, and a data generation section 26b serving as a data generation unit for associating the company code for identifying the seller of the commodity with the commodity sales data to generate electronic receipt information.

The sending section 27 sends the electronic receipt information generated by the electronic receipt generation section 26 to the electronic receipt management server 9 managed by a company unit corresponding to the company code.

As shown in FIG. 9, the CPU 21 (electronic receipt generation section 26) of the POS terminal 2 confirms, if there is an input of, for example, a closing operation key for starting a closing processing of a commodity transaction, whether or not there is an input of the member code and electronic receipt issuing, and determines whether or not there is an electronic receipt issuing instruction corresponding to the settlement processing in response to the closing operation (ACT S1).

The following method is considered for a member to indicate an electronic receipt issuing instruction.

1. A shop clerk operates an “electronic receipt issuing” button arranged on the input section 31 (for example, a keyboard) of the POS terminal 2.

2. A consumer serving as a member displays a barcode containing the code serving as a trigger on the display section 17 of the portable terminal 8, and the shop clerk reads the barcode using the input section 31 (for example, a barcode scanner) of the POS terminal 2.

3. The consumer serving as a member operates the depressible “electronic receipt issuing” button displayed on the display for customer 30.

4. The consumer serving as a member displays a barcode containing the code serving as a trigger on the display section 17 of the portable terminal 8, and then the consumer, that is, the member reads the barcode by himself using the input section 31 (for example, a barcode scanner (a scanner different from the scanner used in commodity registration is preferred)) of the POS terminal 2.

5. The consumer serving as a member presents the company member card for receiving a point service, then the company member code of the company member card is read by the input section 31 (for example, a barcode scanner, a magnetic card reader, or a NFC) of the POS terminal 2, and then it is determined that there is an electronic receipt issuing instruction if the member code of the electronic receipt is associated with the read company member code.

If it is determined that there is an electronic receipt issuing instruction (YES in ACT S1), the CPU 21 (electronic receipt generation section 26) of the POS terminal 2 sends the commodity transaction data to a headquarters server of the company, extracts the commodity transaction data and the like from the identification code management area 23a arranged in the storage section 23, and transfers the data into a format of an electronic receipt to generate electronic receipt detail data (electronic receipt information) (ACT S2). The electronic receipt detail data consists of commodity sales data (transaction date, commodity code, commodity name, sales volume, commodity unit price, total amount of transaction, deposit amount, change amount, payment media and the like) based on the information of the commodity registered at the time of settlement and the information of the settlement based on the commodity sales data processing, a transaction number (receipt number), a register code of the POS terminal 2, and the like. These data are the data with relatively small file capacity, and are generated in a data form such as TEXT, XML, or JSON and the like.

Next, the CPU 21 (sending section 27) of the POS terminal 2 connects with the LAN 4 in the store and the network 5 through the network interface 24, and sends the generated electronic receipt detail data (electronic receipt information) to the electronic receipt management server 9 together with the company code (identification code of a company operating the store), the code of business type and business style, the store code, the member code (consumer) of the electronic receipt (ACT S3), and then ends the processing. In addition, if it is determined that there is no electronic receipt issuing instruction, a paper receipt is printed and issued, the commodity transaction data is sent to the headquarters server, and then the processing is ended.

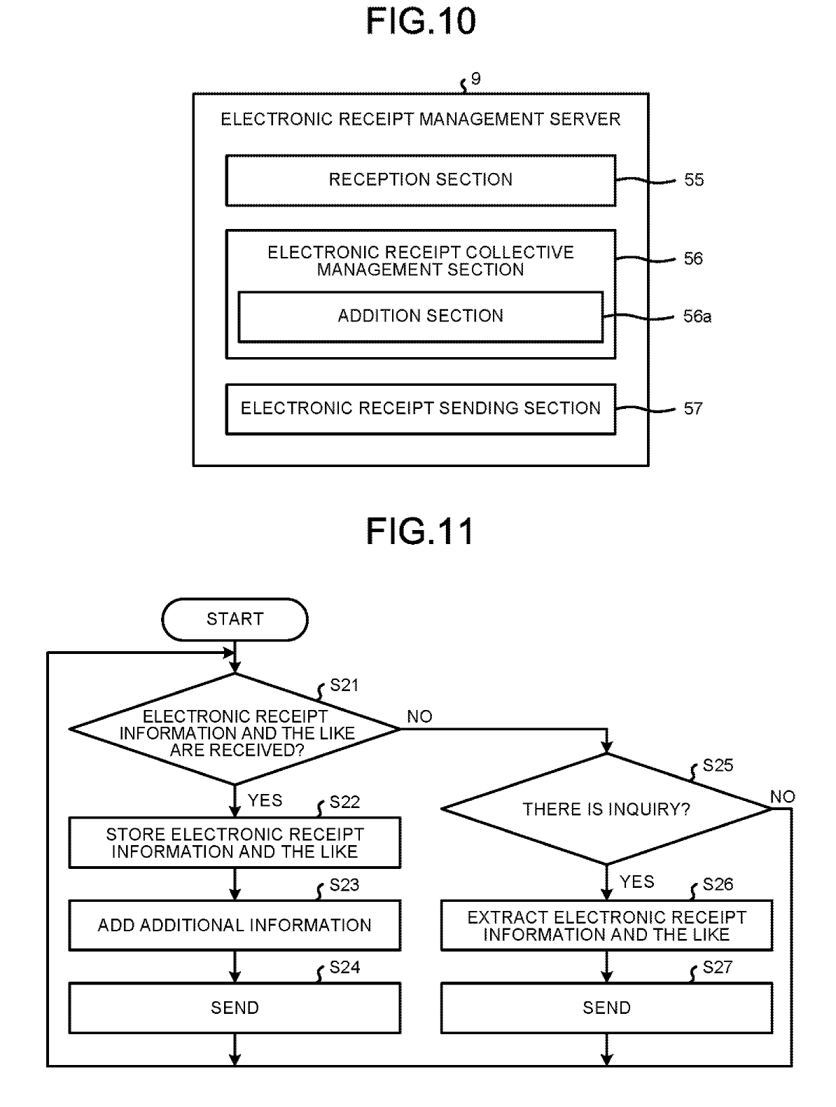

Next, the electronic receipt management processing executed by the CPU 51 of the electronic receipt management server 9 by operating according to the electronic receipt management program P3 and the flow of the commodity information sending processing executed by the CPU 51 by operating according to the information sending program P4 are described with reference to the function block diagram in FIG. 10 and the flowchart in FIG. 11.

As shown in FIG. 10, the electronic receipt management program P3 and the information sending program P4 executed by the electronic receipt management server 9 have a module constitution including a reception section 55 functioning as a reception unit, an electronic receipt collective management section 56 functioning as an electronic receipt collective management unit, and an electronic receipt sending section 57 functioning as an electronic receipt sending unit. As practical hardware, by reading the electronic receipt management program P3 and the information sending program P4 from the storage section 53 and then executing them using the CPU 51, the aforementioned sections are loaded in the memory 52, and the reception section 55, the electronic receipt collective management section 56, and the electronic receipt sending section 57 are generated in the memory 52.

The reception section 55 receives electronically processed electronic receipt information including the company code indicating the company operating the store instead of a receipt printed and issued at the time of the commodity sales data processing.

The electronic receipt collective management section 56 stores the electronic receipt information of the company unit received by the reception section 55 in the electronic receipt management area 53a of the storage section 53 and collectively manages the information. Further, the electronic receipt collective management section 56 comprises an addition section 56a functioning as an addition unit for reading the modification information based on the company code included in the electronic receipt information from the information management area 53b of the storage section 53, and adding the modification information to the electronic receipt information.

The electronic receipt sending section 57 acquires and sends, to the portable terminal 8 corresponding to the member code of a specific consumer, the electronic receipt information containing at least one company code corresponding to the member code from the electronic receipt management area 53a.

As shown in FIG. 11, the CPU 51 (reception section 55) of the electronic receipt management server 9 determines whether or not the company code, code of business type and business style, store code, member code of electronic receipt, electronic receipt detail data (electronic receipt information) sent from the POS terminal 2 of each company are received through the network interface 54 (ACT S21).

If the company code, code of business type and business style, store code, member code of electronic receipt, electronic receipt detail data (electronic receipt information) are received (YES in ACT S21), the CPU 51 (electronic receipt collective management section 56) of the electronic receipt management server 9 stores the electronic receipt information in the electronic receipt management area 53a of the storage section 53 in association with the member code (ACT S22).

Further, the CPU 51 (electronic receipt collective management section 56) of the electronic receipt management server 9 reads, from the information management area 53b of the storage section 53, the modification data (additional information) of the electronic receipt such as the store name logo, campaign data (coupon), commercial data and warranty certificate data and the like corresponding to each code from the company code or store code, and then adds the modification data (additional information) of the electronic receipt to the electronic receipt detail data (electronic receipt information) (ACT S23). The detail data (electronic receipt information) added with the modification data (additional information) is stored in a format which can be browsed by a consumer, and then the creation of the electronic receipt is ended.

As stated above, the POS terminal 2 of the store creates the detail data and sends to the electronic receipt management server 9 of the electronic receipt center, then the electronic receipt management server 9 adds the modification data (additional information) such as the store name logo, campaign data, commercial data and the like, and then an electronic receipt is created. The electronic receipt detail data (electronic receipt information) created by the POS terminal 2 of the store is data with small file capacity, therefore, the load on the network and the system is small even if the electronic receipt detail data (electronic receipt information) is sent to the external electronic receipt management server 9 from the POS terminal 2. On the other hand, the modification data (additional information) of the electronic receipt added by the electronic receipt management server 9 of the electronic receipt center, which includes image data and the like, is data with large file capacity compared with the detail data, therefore, sending the modification data (additional information) will put a large load on the network and the system. Thus, the addition is carried out after the reception by the electronic receipt management server 9, which can reduce the load on the network and the system, and prevent the occurrence of a fault.

In addition, the electronic receipt detail data (electronic receipt information) may also be created in a system at the side of the store such as a store server instead of the POS terminal 2 of the store and then sent to the external electronic receipt management server 9.

Further, the CPU 51 (electronic receipt sending section 57) of the electronic receipt management server 9 stores the electronic receipt information in the electronic receipt management area 53a in a browsable manner, sends a message to the mail address stored in association with the member code of the consumer if the creation of the electronic receipt is completed, and notifies the portable terminal 8 of the consumer that the electronic receipt is updated (ACT S24), and then returns to ACT S21.

In addition, in ACT S24, the CPU 51 (electronic receipt sending section 57) of the electronic receipt management server 9 may also send the electronic receipt information to the mail address stored in association with the member code of the consumer, instead of notifying that the electronic receipt is updated.

Further, if there is an electronic receipt information inquiry from the portable terminal 8 (NO in ACT S21, YES in ACT S25), the CPU 51 (electronic receipt sending section 57) of the electronic receipt management server 9 extracts the electronic receipt information managed by the electronic receipt management area 53a according to the content of the electronic receipt information inquiry (ACT S26), sends to the portable terminal 8 with the inquiry (ACT S27), and then returns to ACT S21.

Further, the CPU 51 (electronic receipt sending section 57) of the electronic receipt management server 9 can manage the sending result of the electronic receipt information by storing a flag indicating that the sending of the electronic receipt information in the electronic receipt management area 53a is completed after the electronic receipt information is sent.

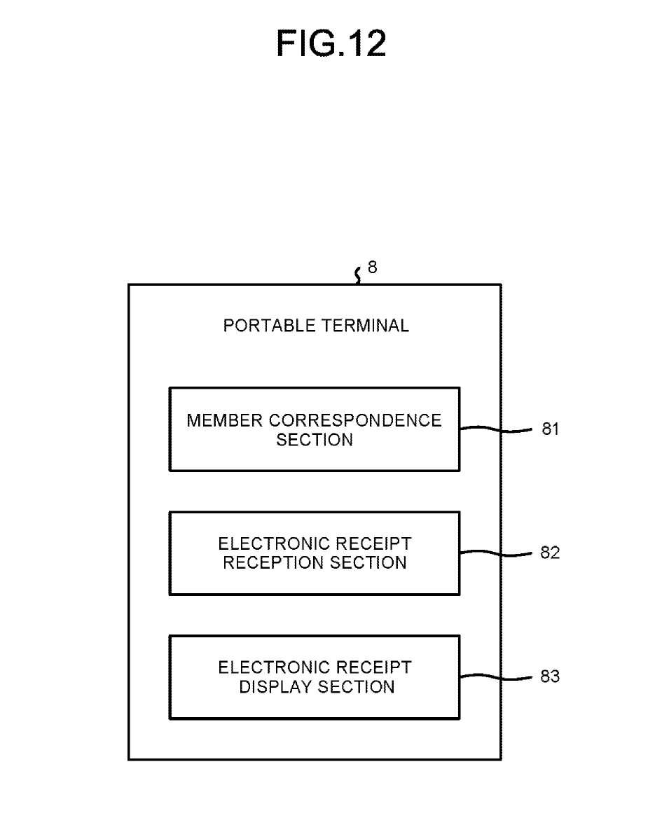

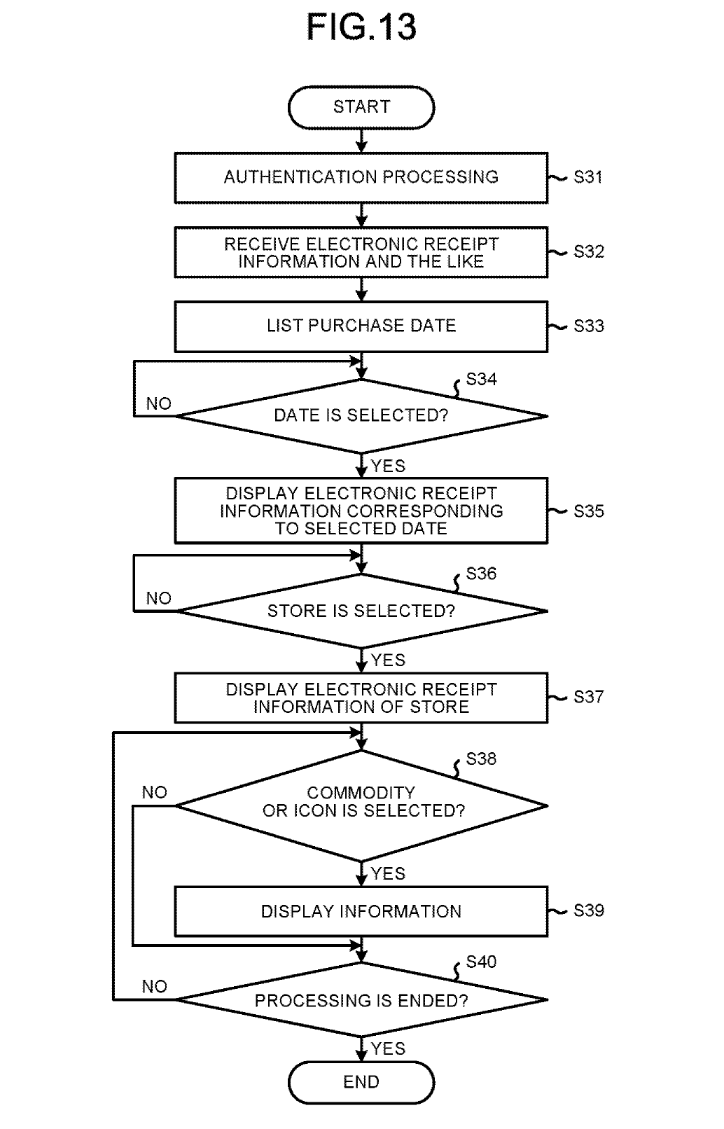

Next, the electronic receipt reception processing executed by the CPU 11 of the portable terminal 8 by operating according to the electronic receipt correspondence program P11 and the flow of the electronic receipt browsing processing executed by the CPU 11 by operating according to the electronic receipt browsing program P12 are described with reference to the function block diagram in FIG. 12 and the flowchart in FIG. 13.

As shown in FIG. 12, the electronic receipt correspondence program P11 and electronic receipt browsing program P12 executed by the portable terminal 8 have a module constitution including a member correspondence section 81 functioning as a member correspondence unit, an electronic receipt reception section 82 functioning as an electronic receipt reception unit, and an electronic receipt display section 83 functioning as an electronic receipt display unit. As practical hardware, by reading the electronic receipt correspondence program P11 and the electronic receipt browsing program P12 from the storage section 13 and then executing them using the CPU 11, the aforementioned sections are loaded in the memory 12, and the member correspondence section 81, the electronic receipt reception section 82, and the electronic receipt display section 83 are generated in the memory 12.

The member correspondence section 81 associates the member code of a specific consumer.

The electronic receipt reception section 82 receives the electronic receipt information containing at least one company code corresponding to the member code from the electronic receipt management server 9 collectively managing the electronic receipt information.

The electronic receipt display section 83 aligns the electronic receipt information received by the electronic receipt reception section 82 at a unit of company code and displays on the display section 17. That is, the electronic receipt display section 83 also functions as an output unit for outputting the electronic receipt information.

As shown in FIG. 13, first, CPU 11 (member correspondence section 81) of the portable terminal 8 accesses the electronic receipt management server 9 to execute an authentication processing according to the input of the member code and the password (ACT S31). Thereby, the portable terminal 8 and the member code of a specific consumer are associated.

After the authentication, the CPU 11 (electronic receipt reception section 82) of the portable terminal 8 receives the electronic receipt information managed by the electronic receipt management area 53a corresponding to the input member code (ACT S32). In addition, the electronic receipt information may also be received through an electronic mail.

Next, the CPU 11 (electronic receipt display section 83) of the portable terminal 8 lists the purchase date contained in the electronic receipt information on the display section 17 (ACT S33). By listing the purchase date on the display section 17, the portable terminal 8 prompts the user serving as a consumer to select the information.

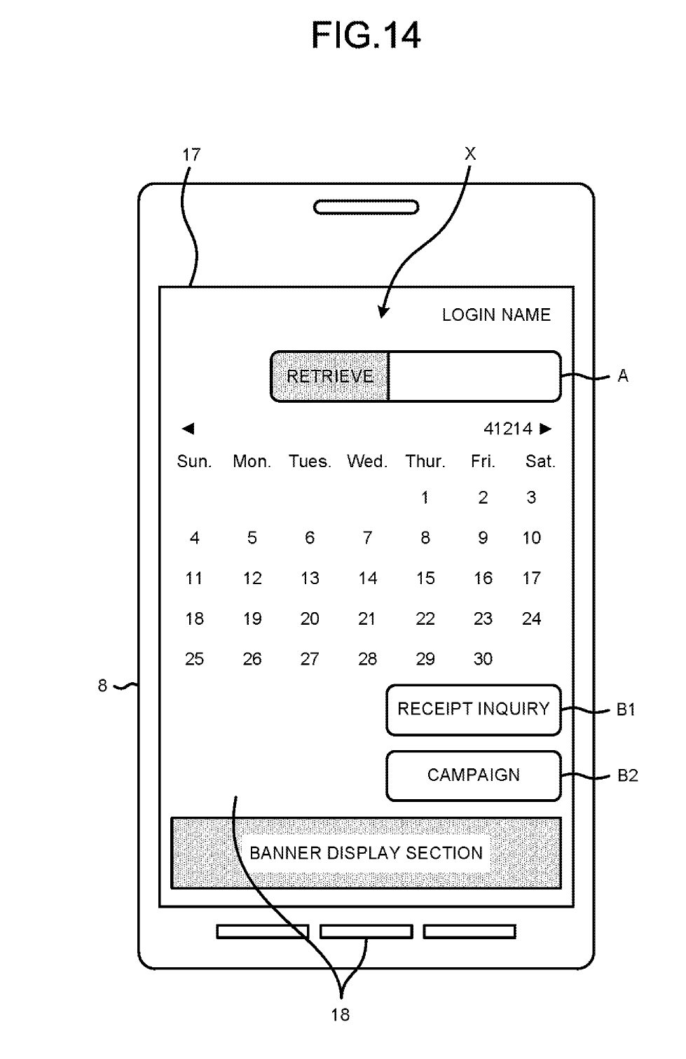

FIG. 14 is a front view illustrating a display example X on the display section 17 of the portable terminal 8. As shown in FIG. 14, in the display example X, the dates when the user owning the portable terminal 8 which has accessed the electronic receipt management server 9 did shopping in stores of various companies are listed in a calendar form with different colors. Further, the CPU 11 (electronic receipt display section 83) of the portable terminal 8 carries out a display in such a manner that the desired date can be selected from the dates listed with different colors using the cursor following the input of the input section 18.

In addition, as shown in FIG. 14, in the display example X, a retrieve window A is arranged for designating a language or a keyword serving as a retrieve key. The CPU 11 of the portable terminal 8 may also narrow down to the electronic receipt information containing the language or the keyword designated in the retrieve window A.

Further, as shown in FIG. 14, the display example X has a “receipt inquiry” button B1 for confirmation after the desired date is selected using the cursor. The CPU 11 of the portable terminal 8 may also determine that it is selected if the desired date is tapped by the user, or determine that it is selected in a case where the “receipt inquiry” button B1 is operated after the desired date is tapped by the user.

If it is determined that the desired date is tapped and selected by the user (YES in ACT S34), the CPU 11 (electronic receipt display section 83) of the portable terminal 8 displays the electronic receipt information corresponding to the selected date on the display section 17 (ACT S35)

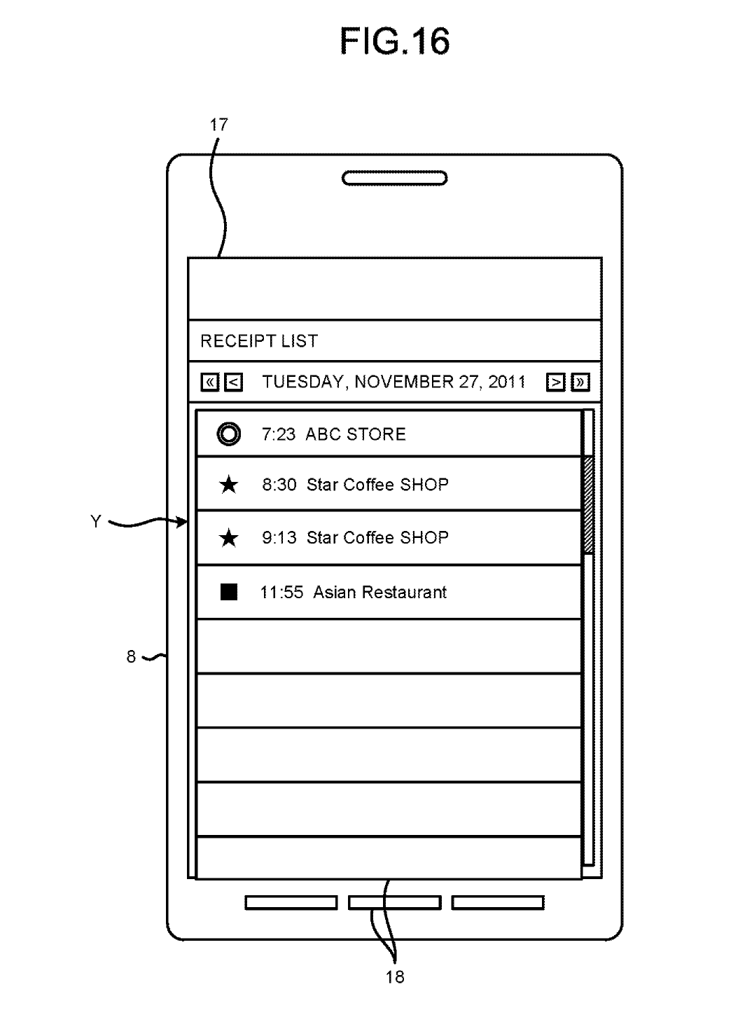

FIG. 16 is a front view illustrating a display example Y in the portable terminal. As shown in FIG. 16, in the display example Y, the stores of various companies where the user owning the portable terminal 8 which has accessed the electronic receipt management server 9 did shopping are listed for each date. More specifically, the display example Y, in which the electronic receipt information is displayed in time series according to the reception order, displays the company mark, transaction time, company name and store name. Further, the CPU 11 (electronic receipt display section 83) of the portable terminal 8 carries out a display in such a manner that the desired store for each date can be selected from the store information listed for each date using the cursor following the input of the input section 18.

If it is determined that the desired store for each date is selected by the user (YES in ACT S36), the CPU 11 (electronic receipt display section 83) of the portable terminal 8 displays the electronic receipt information corresponding to the store for each date on the display section 17 (ACT S37)

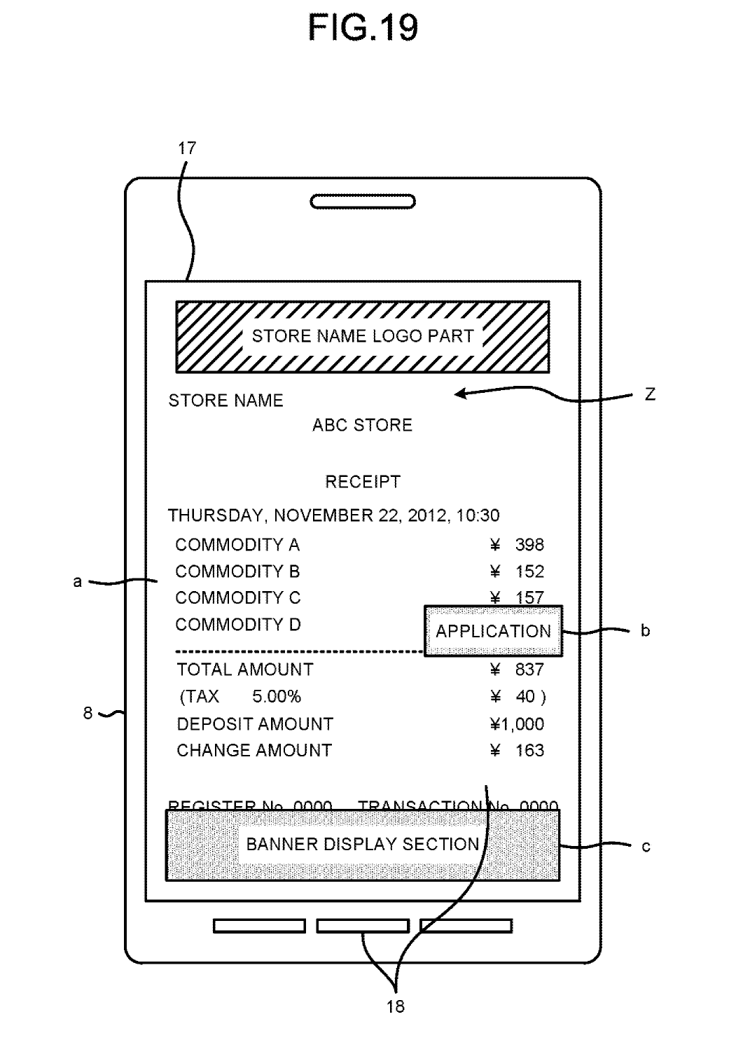

FIG. 19 is a front view illustrating a display example Z on the display section 17 of the portable terminal 8. As shown in FIG. 19, in the display example Z, the electronic receipt information of a desired store in a desired date when the owning the portable terminal 8 which has accessed the electronic receipt management server 9 did shopping is displayed. The display example Z analyzes the electronic receipt information, and has the same layout as the paper receipt. In the display example Z, a commodity a or an icon b (a button shaped icon of “application” in FIG. 19) representing various additional information corresponding to the commodity can be focused using the cursor following the input of the input section 18. Further, the store name logo or banner display, icon and the like are the modification information of the electronic receipt.

In addition, the screen display image is not limited to the receipt image. However, the electronic receipt information, which is the replacement of the paper receipt information, is electronic commodity purchase certificate information for proving the purchase of a commodity. In the display example Z, which will be prompted as commodity purchase certificate information to the store in a case of returning goods, the following information is displayed.

store name

purchase date

purchased commodity detail

sales total amount

deposit amount

change amount

register number

transaction number

Herein, if the user selects a proper commodity or an icon corresponding to a commodity (YES in ACT S38), the CPU 11 (electronic receipt display section 83) of the portable terminal 8 connects with the network 5 through the network interface 14, acquires various kinds of information based on the access information associated with the selected commodity or icon from the network 5, and displays on the display section 17 (ACT S39).

For example, for a commodity a, if a homepage, which is associated with the commodity as access information, is set as a commodity information link, the homepage associated with the commodity is displayed on the display section 17 when the desired commodity is select.

If the completion of the electronic receipt browsing processing is declared from the input section 18 (YES in ACT S40), the CPU 11 of the portable terminal 8 ends the processing.

If the completion of the electronic receipt browsing processing is not declared from the input section 18 (NO in ACT S40), the CPU 11 of the portable terminal 8 returns to ACT S38 to wait for the selection of a commodity or an icon corresponding to the commodity.

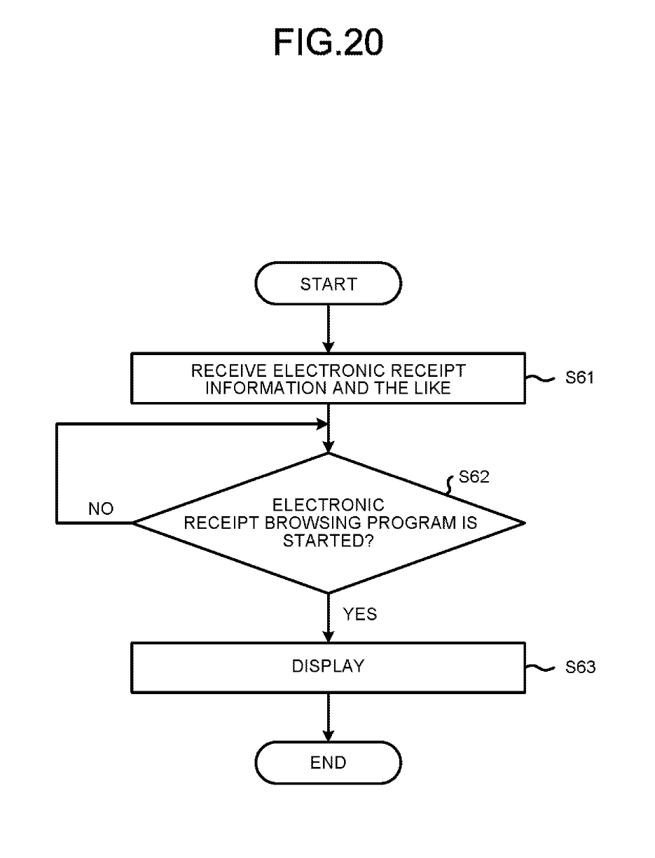

Further, instead of accessing the electronic receipt management server 9 from the portable terminal 8 as stated in ACT S24 in FIG. 11, a case is described with reference to the flowchart in FIG. 20 where the portable terminal 8 receives the electronic receipt information and the additional information from the electronic receipt management server 9.

The CPU 11 (electronic receipt reception section 82) of the portable terminal 8 receives the electronic receipt information and the additional information from the electronic receipt management server 9 (ACT S61).

Then, if the electronic receipt browsing program P12 is started (YES in ACT S62), the CPU 11 (electronic receipt display section 83) of the portable terminal 8 displays the received electronic receipt information and additional information in association with the company code (ACT S63).

In this way, according to the electronic receipt system in the present embodiment, different from the structure of the conventional electronic receipt at a company unit, the structure of electronic receipt beyond the bound of company can be introduced, which can promote the introduction of the electronic receipt.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An electronic receipt system, comprising:
a commodity sales data storage unit configured to store commodity sales data containing a member code for identifying a consumer and transaction data of a commodity associated with the member code in a storage section in association with the member code;
a data generation unit configured to associate a company code for identifying a seller of a commodity with the commodity sales data to generate electronic receipt information;
an additional information storage unit configured to store additional information to be added to the electronic receipt information in a storage section for each of a plurality of company codes;
an addition unit configured to read the additional information based on the company code contained in the electronic receipt information generated by the data generation unit from the storage section, and add to the electronic receipt information; and
an output unit configured to output the electronic receipt information.

2. The electronic receipt system according to claim 1, wherein the additional information is stored in association with the company code.

3. The electronic receipt system according to claim 1, wherein the additional information is larger than the receipt information in file size.

4. A commodity sales data processing apparatus, comprising:
a commodity sales data storage unit configured to store commodity sales data containing a member code for identifying a consumer and transaction data of a commodity associated with the member code in a storage section in association with the member code;
a data generation unit configured to associate a company code for identifying a seller of a commodity with the commodity sales data to generate electronic receipt information; and
a sending unit configured to send the electronic receipt information generated by the data generation unit to an electronic receipt management server.

5. An electronic receipt management server, comprising:
a reception unit configured to receive electronic receipt information which is associated with commodity sales data and corresponds to a plurality of company codes representing companies respectively;
an additional information storage unit configured to store additional information to be added to the electronic receipt information in a storage section for each of the plurality of company codes; and
an addition unit configured to read the additional information based on the company code contained in the electronic receipt information to be managed from the storage section and add the additional information to the electric receipt information respectively associated with each of the company codes received by the reception unit.

6. A commodity sales data processing method, including:
storing commodity sales data containing a member code for identifying a consumer and transaction data of a commodity associated with the member code in a storage section in association with the member code;
associating a company code for identifying a seller of a commodity with the commodity sales data to generate electronic receipt information; and
sending the generated electronic receipt information to an electronic receipt management server.

7. An electronic receipt management method, including:
receiving electronic receipt information which is associated with commodity sales data and corresponds to a plurality of company codes representing companies respectively;
storing additional information to be added to the electronic receipt information in a storage section for each of the plurality of company codes; and
reading the additional information based on the company code contained in the electronic receipt information to be managed from the storage section and adding the additional information to the received electric receipt information respectively associated with each of the company codes.
